(19) United States
(12) Patent Application Publication
(10) Pub. No.: US 2023/0353496 A1
(43) Pub. Date: Nov. 2, 2023

(54) VECTOR-BASED PACKET PROCESSING METHOD AND APPARATUS IN USER PLANE FUNCTION

(71) Applicant: SAMSUNG ELECTRONICS CO., LTD., Suwon-si (KR)

(72) Inventors: Jihwan SEO, Suwon-si (KR); Seonjun PARK, Suwon-si (KR); Beomseok OH, Suwon-si (KR); Sewon OH, Suwon-si (KR)

(21) Appl. No.: 18/345,411

(22) Filed: Jun. 30, 2023

Related U.S. Application Data
(63) Continuation of application No. PCT/KR2022/000024, filed on Jan. 3, 2022.

(30) Foreign Application Priority Data
Jan. 4, 2021 (KR) 10-2021-0000443

(51) Int. Cl. H04L 47/129; H04L 47/24

(52) U.S. Cl. CPC H04L 47/129; H04L 47/24

(57) ABSTRACT

Disclosed is a user plane function (UPF) packet processing control apparatus including: a processor, and a memory storing instructions, wherein the processor is configured to execute the instructions to analyze a state in which UPF packets are processed by a plurality of packet processing pipelines, determine a size of a packet vector for each of the plurality of packet processing pipelines based on a result of the analyzing, and allocate a number of processing cores to each of the plurality of packet processing pipelines based on the result of the analyzing.

### CROSS-REFERENCE TO RELATED APPLICATIONS

This application is a continuation of International Application No. PCT/KR2022/000024 designating the United States, filed on Jan. 3, 2022, in the Korean Intellectual Property Receiving Office and claiming priority to Korean Patent Application No. 10-2021-0000443, filed on Jan. 4, 2021, in the Korean Intellectual Property Office, the disclosures of each of which are incorporated by reference herein in their entireties.

### BACKGROUND

### Field

The disclosure relates to a vector-based packet processing method and apparatus in a user plane function (UPF).

### Description of Related Art

To meet the demand with respect to wireless data traffic having increased since deployment of 4th Generation (4G) communication systems, efforts have been made to develop an improved 5th Generation (5G) or pre-5G communication system. For this reason, 5G or pre-5G communication system is also called ‘Beyond 4G Network’ or ‘Post Long-Term Evolution (LTE) System’. The 5G communication system defined by 3rd Generation Partnership Project (3GPP) is called a New Radio (NR) system. The 5G communication system is considered to be implemented in ultra-high frequency (millimeter (mm)-Wave) bands, (e.g., 60 gigahertz (GHz) bands), so as to accomplish higher data rates. In order to mitigate propagation loss of radio waves and increase a propagation distance of radio waves in an ultra-high frequency band, beamforming, massive multiple-input and multiple-output (MIMO), full-dimensional MIMO (FD-MIMO), array antenna, analog beamforming, and large-scale antenna technologies have been discussed in 5G communication systems and have also been applied to NR systems. In addition, in order to improve a network of a 5G communication system, technologies such as evolved small cells, advanced small cells, cloud radio access networks (cloud RANs), ultra-dense networks, device-to-device (D2D) communication, wireless backhaul, moving networks, cooperative communication, Coordinated Multi-Points (CoMP), and received-interference cancelation, have been developed. In addition, for 5G communication systems, hybrid frequency shift keying (FSK) and quadrature amplitude modulation (QAM) (FQAM) and sliding window superposition coding (SWSC), which are advanced coding modulation (ACM) schemes, and filter bank multi-carrier (FBMC), non-orthogonal multiple access (NOMA), and sparse code multiple access (SCMA), which are advanced access technologies, have been developed.

Meanwhile, the Internet has evolved from a human-centered connection network, through which humans generate and consume information, to an Internet-of-Things (IoT) network that exchanges and processes information between distributed elements such as objects. Internet-of-Everything (IoE) technology in which a big data processing technology via a connection with a cloud server or the like is combined with the IoT technology has also emerged. In order to implement IoT, technical factors, such as sensing technology, wired/wireless communication, network infrastructure, service-interface technology, and security technology are required, and research on technologies, such as a sensor network, machine-to-machine (M2M) communication, machine-type communication (MTC), and the like for connection between objects has recently been conducted. In an IoT environment, via collection and analysis of data generated from connected objects, an intelligent Internet technology (IT) service to create new value for peoples' lives may be provided. IoT may be applied to various fields, such as smart homes, smart buildings, smart cities, smart cars or connected cars, smart grids, health care, smart home appliances, or high-tech medical services, via the convergence and combination of existing information technology (IT) and various industries.

Accordingly, various attempts are being made to apply 5G communication systems to IoT networks. For example, technologies such as a sensor network, M2M communication, and MTC are implemented by beamforming, MIMO, or array antenna schemes. The application of cloud RAN as the big data processing technology described above may be an example of convergence of 5G communication technology and IoT technology.

As it is now possible to provide various services according to the development of wireless communication systems, there is a need for a method of efficiently providing the services.

Meanwhile, an artificial intelligence (AI) system refers to a system in which a machine learns, performs determination on its own, and becomes smart, unlike existing rule-based smart systems. As the AI system is more frequently used, the recognition rate of the AI system is improved and accurately understands a user's preference, and accordingly, the existing rule-based smart systems have gradually been replaced with deep-learning-based AI systems. AI technology includes machine learning (deep learning) and element technologies utilizing machine learning. The machine learning refers to an algorithm technology that classifies/learns features of input data by itself, and the element technologies are technologies that utilize machine learning algorithms such as deep learning, and cover technical fields such as linguistic understanding, visual understanding, inference/prediction, knowledge representation, operation control, and the like.

### SUMMARY

Embodiments of the disclosure provide a method and apparatus for processing user plane function (UPF) packets based on a vector according to a packet processing state, such that UPF packets may be efficiently processed.

An example embodiment of the present disclosure may provide a user plane function (UPF) packet processing control apparatus including: a processor, and a memory storing instructions, wherein the processor by executing the instructions is configured to: analyze a state in which UPF packets are processed by a plurality of packet processing pipelines, determine a size of a packet vector for each of the plurality of packet processing pipelines based on a result of the analyzing, and allocate a number of processing cores to each of the plurality of packet processing pipelines based on the result of the analyzing.

In an example embodiment, the plurality of packet processing pipelines may be configured to process packets of different types.

In an example embodiment, the types of the packets may be defined according to at least one of a direction of a communication link, a type of a communication protocol, a version of the communication protocol, or a communication rule.

In an example embodiment, each of the plurality of packet processing pipelines may include a packet processing pipeline dedicated to process packets of a particular type.

In an example embodiment, the processor may be configured to: receive a UPF packet, select one of the plurality of packet processing pipelines based on the type of the received UPF packet, and deliver the received UPF packet to the selected packet processing pipeline.

An example embodiment of the present disclosure may provide a method of operating a UPF packet processing control apparatus including: analyzing a state in which UPF packets are processed by a plurality of packet processing pipelines, determining a size of a packet vector for each of the plurality of packet processing pipelines based on a result of the analyzing, and allocating a number of processing cores to each of the plurality of packet processing pipelines based on the result of the analyzing.

In an example embodiment, the plurality of packet processing pipelines may be configured to process packets of different types.

In an example embodiment, the types of the packets may be defined according to at least one of a direction of a communication link, a type of a communication protocol, a version of the communication protocol, or a communication rule.

In an example embodiment, each of the plurality of packet processing pipelines may include a packet processing pipeline dedicated to process packets of a particular type.

In an example embodiment, the method of operating the packet processing control apparatus may further include: receiving a UPF packet, selecting one of the plurality of packet processing pipelines based on the type of the received UPF packet, and delivering the received UPF packet to the selected packet processing pipeline.

An example embodiment of the present disclosure includes a program product including a program stored in a computer-readable recording medium that, when executed, causes a computer to perform operations according to the method.

An example embodiment of the present disclosure includes a non-transitory computer-readable recording medium having recorded thereon a program which, when executed, causes a computer to perform the method according to an embodiment of the present disclosure.

An example embodiment of the present disclosure provides a method and apparatus for processing packets based on a vector according to a packet processing state, such that user plane function (UPF) packets may be efficiently processed.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example configuration of a user plane function (UPF) packet processing control apparatus according to various embodiments;

FIG. 2 is a flowchart illustrating an example method of operating a UPF packet processing control apparatus according to various embodiments;

FIG. 3 is a diagram illustrating an example configuration of a UPF packet processing system according to various embodiments;

FIG. 4 is a diagram illustrating an example configuration of a UPF packet processing system according to various embodiments;

FIG. 5 is a diagram illustrating an example configuration of a UPF packet processing system according to various embodiments; and

FIG. 6 is a diagram illustrating an example configuration of a UPF packet processing system according to the related art.

### DETAILED DESCRIPTION

Hereinafter, various example embodiments of the present disclosure will be described in greater detail with reference to the accompanying drawings. In describing the present disclosure, detailed description of related well-known functions or configurations may be omitted when it is deemed that they may unnecessarily obscure the essence of the present disclosure. Components having substantially the same functional configuration in the drawings are assigned the same reference numerals and reference characters as possible even though they are indicated on different drawings. When necessary for convenience of description, an apparatus and a method will be described together. Each operation of the present disclosure does not necessarily have to be performed in the order described herein, and may be performed in parallel, selectively, or individually.

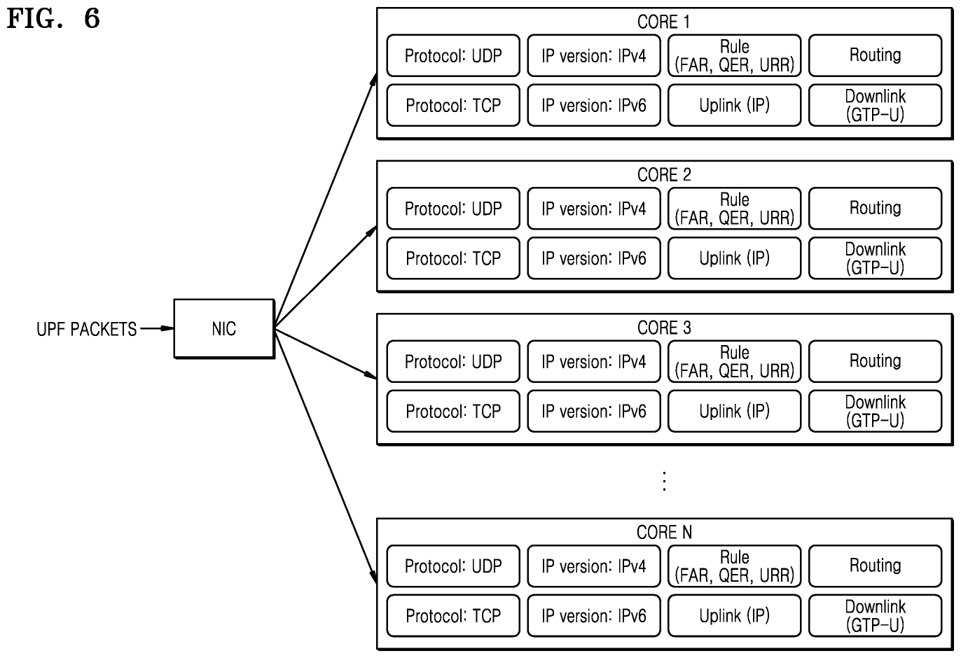

In processing user plane function (UPF) packets (hereinafter, also simply referred to as ‘packets’) in a UPF, a technique for processing packets based on a vector of packets (or a packet vector, hereinafter, also simply referred to as a ‘vector’) may be used, and a related-art technique as shown in FIG. 6 processes all packets in the same way without considering information about packets that vary according to time and place. For example, UPF packets may be classified into various types according to the direction of a communication link, the type of a communication protocol, a method of processing a communication protocol, etc., and in the related-art technique, all processing cores (hereinafter, also simply referred to as ‘cores’) are identically configured to process all types of packets, and received packets are distributed to each core regardless of the types of the packets and then processed. In addition, the type or amount of packets, the state of cores and memories, etc. may change in real time, but the related-art technique does not consider such changes in performing vector-based packet processing. The present disclosure provides a technique for efficiently processing packets based on a vector considering such various factors. As used herein, the term ‘UPF’ does not necessarily refer only to a UPF in 5th Generation (5G) communication protocols, but may encompass a component that generally handles a function of a user plane regardless of communication protocols. Similarly, as used herein, the term ‘UPF packet’ does not necessarily refer only to a UPF packet in 5G communication, but may generally encompass a packet in a user plane regardless of communication protocols.

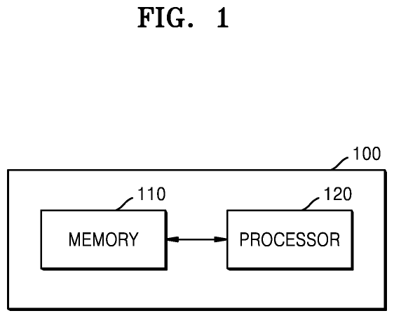

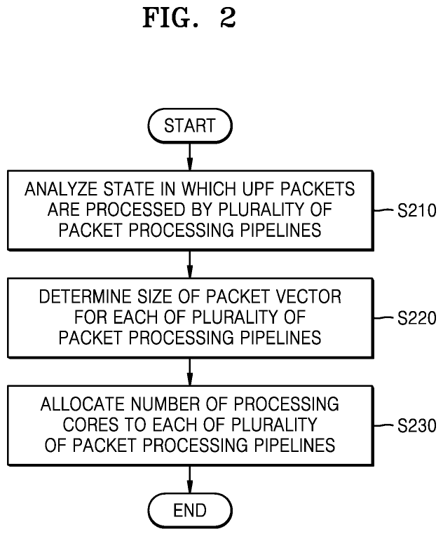

FIG. 1 is a block diagram illustrating an example configuration of a UPF packet processing control apparatus according to various embodiments. Referring to FIG. 1, a UPF packet processing control apparatus 100 according to an embodiment of the present disclosure may include an apparatus for controlling processing of packets received by a UPF, and may include a processor (e.g., including processing circuitry) 110 and a memory 120 storing one or more instructions executable by the processor. An operation of the UPF packet processing control apparatus 100 performed by the processor 110 executing the one or more instructions stored in the memory 120 will be described in greater detail below with reference to FIGS. 2 to 5.

FIG. 2 is a flowchart illustrating an example method of operating the UPF packet processing control apparatus 100 according to various embodiments.

Referring to FIG. 2, in operation S210, the processor 110 of the UPF packet processing control apparatus 100 analyzes a state in which UPF packets are processed by a plurality of packet processing pipelines. Each packet processing pipeline is a pipeline that processes a particular type of UPF packet, and will be described in detail below.

For each packet processing pipeline or core, the processor 110 may monitor packet information (e.g. type of packet, amount of packets), the number of packets of a particular type received by the UPF, the number of cores currently allocated to the packet processing pipeline, the number of packets received by the packet processing pipeline/core, the size of a vector of the packet processing pipeline/core, load information of the packet processing pipeline/core, packet flow information of the packet processing pipeline/core (e.g., RX/TX information of packets or packet drop information), cycle information of the packet processing pipeline/core (e.g., a total execution cycle, an idle cycle, an RX logic cycle, a TX logic cycle or an intermediate component cycle), memory information of the packet processing pipeline/core, etc., and analyze a packet processing state based on the monitored information. The processor 110 may analyze the header and/or payload values of packets to identify and classify the characteristics of the packets.

For example, for each of the packet processing pipelines, the processor 110 may analyze the packet processing state based on at least one of the size of the current packet vector of the packet processing pipeline, the number of cores currently allocated to the packet processing pipeline, cycle information of the packet processing pipeline, the number of packets received by the packet processing pipeline, or the number of packets of a particular type received by the UPF.

The processor 110 may analyze the packet processing state by determining the amount of resources used by each packet processing pipeline or core. The processor 110 may analyze the packet processing state by determining the degree of busyness of each packet processing pipeline or core.

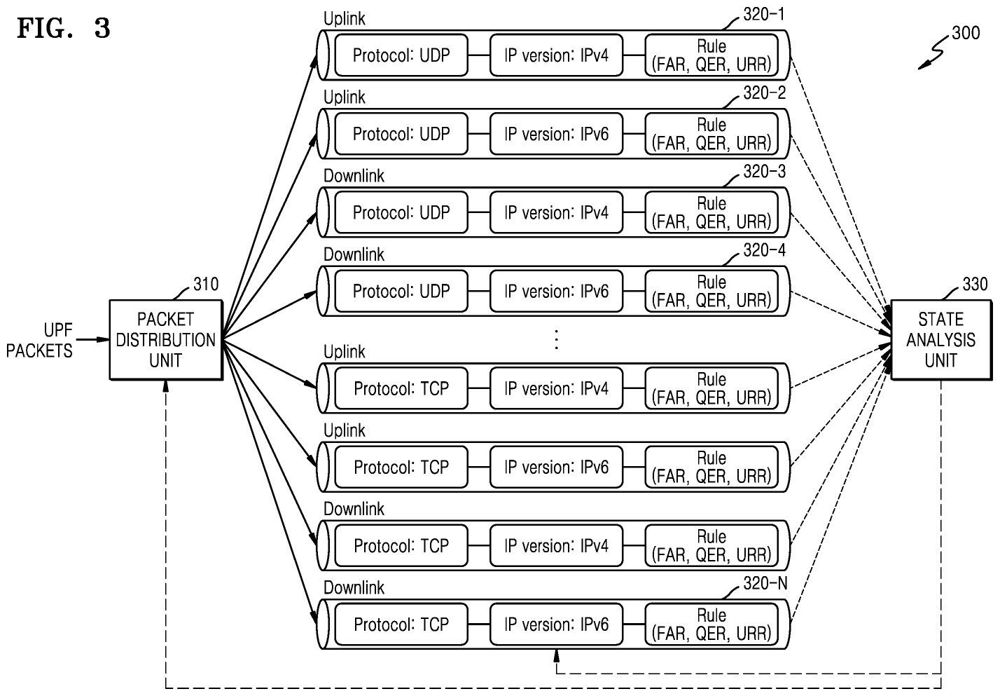

In operation S220, the processor 110 may determine the size of a packet vector for each of a plurality of packet processing pipelines 320-1 to 320-N (refer to FIG. 3) based on a result of analyzing the packet processing state.

In operation S230, the processor 110 may allocate a number of processing cores to each of the plurality of packet processing pipelines 320-1 to 320-N based on the result of analyzing the packet processing state. The processor 110 may allocate a number of processing cores to each packet processing pipeline based on the vector size of the packet processing pipeline. The processor 110 may allocate zero or more cores to each packet processing pipeline. That is, the processor 110 may not allocate cores to a certain processing pipeline. The processor 110 may allocate a particular core to each packet processing pipeline. Operations S220 and S230 are not necessarily performed in the described order. According to an embodiment, the processor 110 may determine different sizes of packet vectors for a plurality of cores allocated to one pipeline.

For example, when a situation is detected in which the throughput for a particular type of packet is insufficient, the processor 110 may increase the size of the vector of the packet processing pipeline, and allocate more cores to the packet processing pipeline. The processor 110 may determine the vector size and the number of cores of each packet processing pipeline using artificial intelligence, an artificial neural network, machine learning, etc. The processor 110 may continuously update the vector size and the number of cores of each packet processing pipeline according to the packet processing state that changes in real time.

In an embodiment, as the degree of busyness of a packet processing pipeline increases, the processor 110 may increase the number of cores allocated to the packet processing pipeline. Here, that the degree of busyness increases may include that the execution cycle of the packet processing pipeline (e.g., the total execution cycle of the packet processing pipeline or the execution cycle of an internal component of the packet processing pipeline) increases. That the execution cycle increases may be, for example, that the absolute value or a relative value of the execution cycle becomes greater than or equal to a preset threshold value. That the degree of busyness increases may include that the idle cycle decreases. That the idle cycle decreases may be, for example, that the absolute value or a relative value of the idle cycle becomes less than or equal to a preset threshold value.

In an embodiment, as the degree of busyness of a packet processing pipeline or core increases, the processor 110 may increase the size of a packet vector of the packet processing pipeline or core. The size of the packet vector may be adjusted in proportion to the degree of busyness, or the value may be determined through inference by a machine learning model.

In an embodiment, as the degree of busyness of the packet processing pipeline increases when the size of the packet vector of the packet processing pipeline is at a maximum, the processor 110 may increase the number of cores allocated to the packet processing pipeline.

In an embodiment, as the degree of busyness of a packet processing pipeline decreases, the processor 110 may decrease the number of cores allocated to the packet processing pipeline.

In an embodiment, as the degree of busyness of a packet processing pipeline or core decreases, the processor 110 may decrease the size of a packet vector of the packet processing pipeline or core.

In an embodiment, as the degree of busyness of the packet processing pipeline decreases when the size of the packet vector of the packet processing pipeline is at a minimum, the processor 110 may decrease the number of cores allocated to the packet processing pipeline.

In an embodiment, when the absolute value or a relative value of the idle cycle of a packet processing pipeline is greater than or equal to a preset threshold value, the processor 110 may decrease the number of cores allocated to the packet processing pipeline. For example, when the number of cores currently allocated to a packet processing pipeline is k and the proportion of the idle cycle of the packet processing pipeline is greater than 1/k, the processor 110 may decrease the number of cores allocated to the packet processing pipeline by 1.

In an embodiment, as the number of packets received by a packet processing pipeline increases, the processor 110 may increase the number of cores allocated to the packet processing pipeline.

In an embodiment, as the number of packets received by a packet processing pipeline or core increases, the processor 110 may increase the size of a packet vector of the packet processing pipeline or core.

In an embodiment, as the number of packets received by the packet processing pipeline increases when the size of the packet vector of the packet processing pipeline is at a maximum, the processor 110 may increase the number of cores allocated to the packet processing pipeline.

In an embodiment, as the number of packets of a particular type received by the UPF increases, the processor 110 may increase the number of cores allocated to the corresponding packet processing pipeline.

In an embodiment, as the number of packets of a particular type received by the UPF increases, the processor 110 may increase the size of a packet vector of the corresponding packet processing pipeline or core.

In an embodiment, as the number of packets of the type received by the UPF increases when the size of the packet vector of the packet processing pipeline is at a maximum, the processor 110 may increase the number of cores allocated to the packet processing pipeline.

As such, the UPF packet processing control apparatus 100 according to an embodiment of the present disclosure may perform optimal vector-based packet processing by actively determining an optimal vector size and the number of cores for each packet processing pipeline according to a real-time packet processing state.

FIG. 3 is a diagram illustrating an example configuration of a UPF packet processing system according to various embodiments. Referring to FIG. 3, a UPF packet processing system 300 according to an embodiment of the present disclosure may include a plurality of packet processing pipelines 320-1 to 320-N.

According to an embodiment, the packet processing pipelines 320-1 to 320-N may be configured to process packets of different types. That is, there may be only one packet processing pipeline configured to process packets of one type.

According to an embodiment, some packet processing pipelines may be configured to process packets of the same type. That is, there may be a plurality of packet processing pipelines configured to process packets of one type.

Each of the packet processing pipelines 320-1 to 320-N may be a dedicated packet processing pipeline that is able to process only packets of a particular type, and is unable to process packets of other types. In other words, a separate packet processing pipeline may be provided according to each type of packet. A plurality of dedicated packet processing pipelines for one type of packet may be provided.

The packet processing pipelines 320-1 to 320-N may operate independently of each other.

The type of packet that may be processed by each packet processing pipeline may be defined according to various criteria. The type of packet may be defined according to at least one of the direction of communication link, the type of communication protocol, or the version of communication protocol. The type of packet may be defined according to all of the direction of communication link, the type of communication protocol, and the version of communication protocol. The direction of communication link may include uplink and downlink. The type of communication protocol may include the protocol type of a transport layer such as transmission control protocol (TCP)/user datagram protocol (UDP). The version of communication protocol may include an Internet protocol version such as Internet Protocol version 4 (IPv4) or Internet Protocol version 6 (IPv6).

For example, a first packet type may include packets corresponding to uplink, UDP, and IPv4, a second packet type may include packets corresponding to uplink, UDP, and IPv6, and an N-th packet type may include packets corresponding to downlink, TCP, and IPv6. In this case, the first packet processing pipeline 320-1 may process only packets of the first packet type corresponding to uplink, UDP, and IPv4, and the second packet processing pipeline 320-1 may processes only packets of the second packet type corresponding to uplink, UDP, and IPv6, and the N-th packet processing pipeline 320-N may process only packets of the N-th packet type corresponding to downlink, TCP, and IPv6. Accordingly, the first packet processing pipeline 320-1 needs to have only functions for processing uplink, UDP, and IPv4, and does not need to have other functions related to downlink, TCP, or IPv6. The second packet processing pipeline 320-1 may be configured to process uplink, UDP, and IPv6, and does not need to have functions related to downlink, TCP, or IPv4. The N-th packet processing pipeline 320-N may process downlink, TCP, and IPv6, and does not need to have functions related to uplink, UDP, or IPv4.

The packet processing pipelines may be distinguished from each other by communication rule. That is, packets with similar communication rules may be regarded as packets of the same type and processed by one packet processing pipeline. The communication rules may include packet forwarding rules such as forwarding action rule (FAR), quality of service (QoS) enforcement rules (QER), or usage reporting rules (URR).

The type of packet may be defined according to at least one of the direction of communication link, the type of communication protocol, the version of communication protocol, or a communication rule. The type of packet may be defined according to all of the direction of communication link, the type of communication protocol, the version of communication protocol, or a communication rule.

As described above, one or more processing cores may be allocated to a packet processing pipeline, and in some cases, no processing core may be allocated to a packet processing pipeline.

The UPF packet processing system 300 may include a packet distribution unit (e.g., including various processing circuitry and/or executable program instructions) 310 and a state analysis unit (e.g., including various processing circuitry and/or executable program instructions) 330. A UPF packet received by the UPF packet processing system 300 may be delivered by the packet distribution unit 310 to the packet processing pipeline corresponding to the type of the packet among the packet processing pipelines 320-1 to 320-N. Each packet may be processed by the corresponding packet processing pipeline, and the state analysis unit 330 may analyze a state in which the packets are processed by the packet processing pipelines, to determine the vector size and the number of cores of each packet processing pipeline. The operation of the state analysis unit 330 is the same as or similar to that of the UPF packet processing control apparatus 100 described above, and the state analysis unit 330 may be included in the UPF packet processing control apparatus 100. The vector size and the number of cores determined by the state analysis unit 330 may be delivered to the packet processing pipelines 320-1 to 320-N and/or the packet distribution unit 310.

The packet distribution unit 310 may deliver one packet or a preset number of packets at a time to each packet processing pipeline regardless of the vector size of the packet processing pipeline, and each packet processing pipeline may configure a vector of received packets according to the vector size of the packet processing pipeline, and process the packets. According to an embodiment, the packet distribution unit 310 may collect packets according to the vector size of each packet processing pipeline, configure a vector of the collected packets, and deliver the vector to the packet processing pipeline. According to an embodiment, the packet distribution unit 310 may be included in the UPF packet processing control apparatus 100. That is, the processor 110 of the UPF packet processing control apparatus 100 may receive a UPF packet, select one of the plurality of packet processing pipelines 320-1 to 320-N based on the type of the received UPF packet, and deliver the UPF packet to the selected packet processing pipeline. In a case in which there are a plurality of packet processing pipelines corresponding to the type of the received UPF packet, the processor 110 may select the most idle packet processing pipeline from among the plurality of packet processing pipelines, and deliver the UPF packet to the selected packet processing pipeline. The processor 110 may select the packet processing pipeline having the lowest degree of busyness among the packet processing pipelines corresponding to the type of the received UPF packet, and deliver the UPF packet to the selected packet processing pipeline. The processor 110 may select the packet processing pipeline having the highest idle cycle among the packet processing pipelines corresponding to the type of the received UPF packet, and deliver the UPF packet to the selected packet processing pipeline.

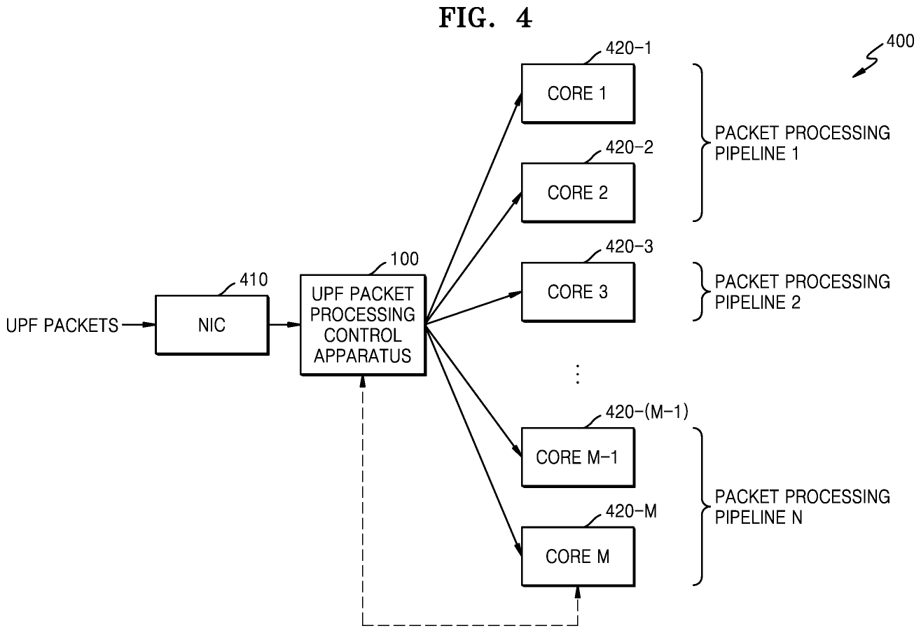

FIG. 4 is a diagram illustrating an example configuration of a UPF packet processing system 400 according to various embodiments. Referring to FIG. 4, the UPF packet processing system 400 according to an embodiment of the present disclosure may include a network interface controller (NIC) 410, the UPF packet processing control apparatus (e.g., including various processing circuitry and/or executable program instructions) 100, and a plurality of processing cores 420-1 to 420-M. One of the plurality of packet processing pipelines 320-1 to 320-N may be allocated to each of the processing cores 420-1 to 420-M. One packet processing pipeline may be allocated to several processing cores.

The UPF packet processing control apparatus 100 may determine the vector size and the number of cores of each packet processing pipeline by analyzing a state in which packets are processed by the processing cores 420-1 to 420-M, and the detailed operation thereof is as described above. The vector sizes determined by the UPF packet processing control apparatus 100 may be delivered to the processing cores 420-1 to 420-M.

The NIC 410 may deliver a received UPF packet to the UPF packet processing control apparatus 100. The UPF packet processing control apparatus 100 may deliver the UPF packet to the processing core corresponding to the type of the UPF packet among the processing cores 420-1 to 420-M. The UPF packet processing control apparatus 100 may deliver one packet or a preset number of packets at a time to each processing core regardless of the vector size of the processing core, and may also configure a packet vector according to the vector size of each processing core and deliver the packet vector to the processing core. The UPF packet processing control apparatus 100 may include the packet distribution unit 310.

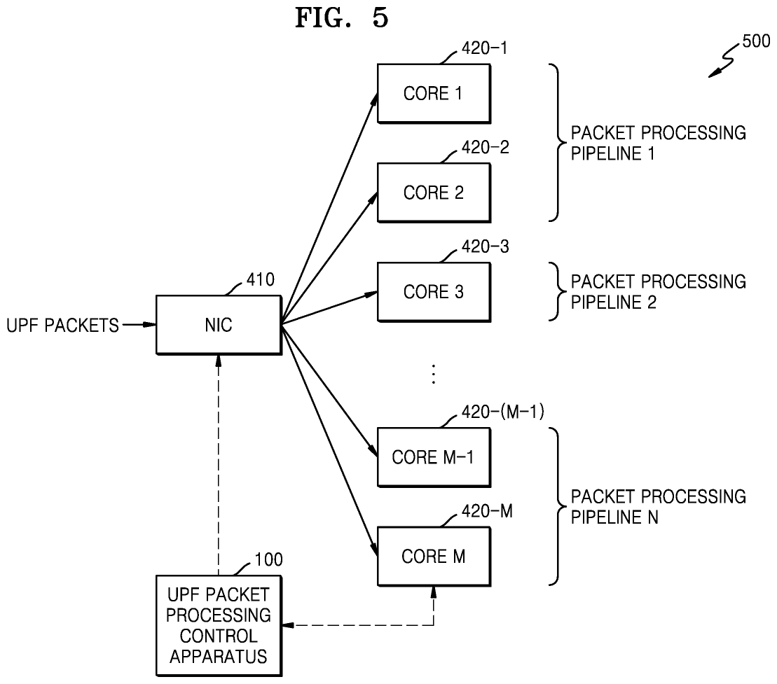

FIG. 5 is a diagram illustrating an example configuration of a UPF packet processing system 500 according to various embodiments. In describing the embodiment of FIG. 5, descriptions provided above may not be repeated. Referring to FIG. 5, the NIC 410 may directly deliver a received UPF packet to the corresponding processing core among the processing cores 420-1 to 420-M. To this end, information about cores allocated by the UPF packet processing control apparatus 100 to the packet processing pipelines for the respective types of packet may be delivered to the NIC 410.

The NIC 410 may deliver one packet or a preset number of packets at a time to each processing core regardless of the vector size of the processing core, and may also configure a packet vector according to the vector size of each processing core and deliver the packet vector to the processing core. The vector size of each core determined by the UPF packet processing control apparatus 100 may be delivered to the NIC 410.

An embodiment of the present disclosure may be implemented as a recording medium including computer-executable instructions, such as a computer-executable program module. The computer-readable medium may be any available medium which is accessible by a computer, and may include a volatile or non-volatile medium and a removable or non-removable medium. Also, the computer-readable medium may include a computer storage medium and a communication medium. The computer storage media include both volatile and non-volatile, removable and non-removable media implemented in any method or technique for storing information such as computer readable instructions, data structures, program modules or other data. The communication medium may typically include computer-readable instructions, data structures, or other data of a modulated data signal such as program modules.

In addition, the computer-readable storage medium may be provided in the form of a non-transitory storage medium. Here, the ‘non-transitory storage medium’ may refer, for example, to a tangible device and may not include a signal (e.g., an electromagnetic wave), and the term ‘non-transitory storage medium’ does not distinguish between a case where data is stored in a storage medium semi-permanently and a case where data is stored temporarily. For example, the non-transitory storage medium may include a buffer in which data is temporarily stored.

According to an embodiment, the methods according to various embodiments disclosed herein may be included in a computer program product and then provided. The computer program product may be traded as commodities between sellers and buyers. The computer program product may be distributed in the form of a machine-readable storage medium (e.g., a compact disc read-only memory (ROM) (CD-ROM)), or may be distributed online (e.g., downloaded or uploaded) through an application store (e.g., Play Store™) or directly between two user devices (e.g., smart phones). In a case of online distribution, at least a portion of the computer program product (e.g., a downloadable app) may be temporarily stored in a machine-readable storage medium such as a manufacturer's server, an application store's server, or a memory of a relay server.

In addition, as used herein, terms such as “ . . . er (or)”, “ . . . unit”, “ . . . module”, etc., denote a unit that performs at least one function or operation, which may be implemented as hardware or software or a combination thereof.

In addition, as used herein, the expression “include at least one of a, b or c” may refer, for example, to “include only a”, “include only b”, “include only c”, “include a and b”, “include b and c”, “include a and c”, or “include a, b, and c”.

Functions related to artificial intelligence according to the present disclosure are performed by a processor and a memory. The processor may include one or more processors. In this case, the one or more processors may be a general-purpose processor, such as a central processing unit (CPU), an application processor (AP), or a digital signal processor (DSP), a dedicated graphics processor, such as a graphics processing unit (GPU) or a vision processing unit (VPU), or a dedicated artificial intelligence processor, such as a neural processing unit (NPU). The one or more processors perform control to process input data according to predefined operation rules or an artificial intelligence model stored in the memory. Alternatively, in a case in which the one or more processors are dedicated artificial intelligence processors, the dedicated artificial intelligence processor may be designed with a hardware structure specialized for processing a particular artificial intelligence model.

The present disclosure has been described in detail, with reference to various example embodiments illustrated in the drawings. The embodiments are only illustrative without limiting the present disclosure and should be understood in the illustrative sense only and not for the purpose of limitation. It will be understood by those of skill in the art to which the present disclosure belongs that various changes in form and details may be made in the embodiments without changing the technical spirit and mandatory features of the present disclosure. For example, each component described as a single type may be carried out by being distributed, and likewise, components described as a distributed type may also be carried out by being coupled. Although particular terms are used in the present disclosure, the terms are for the purpose of describing the present disclosure only and are not intended to be limiting of the meaning or the scope of the present disclosure as defined by the claims.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A packet processing control apparatus configured to control packet processing of a user plane function (UPF), the packet processing control apparatus comprising:
a processor; and
a memory storing instructions,
wherein the processor by executing the instructions is configured to: analyze a state in which UPF packets are processed by a plurality of packet processing pipelines, determine a size of a packet vector for each of the plurality of packet processing pipelines based on a result of the analyzing, and allocate a number of processing cores to each of the plurality of packet processing pipelines based on the result of the analyzing.

2. The packet processing control apparatus of claim 1, wherein the plurality of packet processing pipelines are configured to process packets of different types.

3. The packet processing control apparatus of claim 2, wherein the types of the packets are defined according to at least one of a direction of a communication link, a type of a communication protocol, a version of the communication protocol, or a communication rule.

4. The packet processing control apparatus of claim 1, wherein the processor is further configured to: analyze the state in which the UPF packets are processed by the plurality of packet processing pipelines for each of the plurality of packet processing pipelines, based on at least one of a size of a current packet vector of the packet processing pipeline, a number of cores currently allocated to the packet processing pipeline, cycle information of the packet processing pipeline, a number of packets received by the packet processing pipeline, or a number of packets of a type received by the UPF.

5. The packet processing control apparatus of claim 1, wherein the processor is further configured to: increase the number of processing cores allocated to each of the plurality of packet processing pipelines as an idle cycle decreases.

6. The packet processing control apparatus of claim 1, wherein the processor is further configured to: increase the size of the packet vector for each of the plurality of packet processing pipelines as an idle cycle decreases.

7. The packet processing control apparatus of claim 6, wherein the processor is further configured to: increase the number of the processing cores allocated to each of the plurality of packet processing pipelines as an idle cycle decreases when the size of the packet vector is at a maximum.

8. The packet processing control apparatus of claim 1, wherein each of the plurality of packet processing pipelines includes a packet processing pipeline dedicated to process packets of a particular type.

9. The packet processing control apparatus of claim 1, wherein the processor is further configured to: receive a UPF packet, select one of the plurality of packet processing pipelines based on a type of the received UPF packet, and deliver the received UPF packet to the selected packet processing pipeline.

10. The packet processing control apparatus of claim 9, wherein the processor is further configured to: select a packet processing pipeline having a highest idle cycle from among packet processing pipelines corresponding to the type of the received UPF packet.

11. A method of operating a user plane function (UPF) packet processing control apparatus, the method comprising:
analyzing a state in which UPF packets are processed by a plurality of packet processing pipelines;
determining a size of a packet vector for each of the plurality of packet processing pipelines based on a result of the analyzing; and
allocating a number of processing cores to each of the plurality of packet processing pipelines based on the result of the analyzing.

12. The method of claim 11, wherein the plurality of packet processing pipelines are configured to process packets of different types.

13. The method of claim 11, wherein the types of the packets are defined according to at least one of a direction of a communication link, a type of a communication protocol, a version of the communication protocol, or a communication rule.

14. The method of claim 11, wherein the analyzing of the state in which the UPF packets are processed by the plurality of packet processing pipelines comprises, for each of the plurality of packet processing pipelines: analyzing the state in which the UPF packets are processed by the plurality of packet processing pipelines, based on at least one of a size of a current packet vector of the packet processing pipeline, a number of cores currently allocated to the packet processing pipeline, cycle information of the packet processing pipeline, a number of packets received by the packet processing pipeline, or a number of packets of a type received by a UPF.

15. A non-transitory computer-readable recording medium having recorded thereon a program which, when executed by a computer, causes the computer to perform operations recited in claim 11.
